(19) United States
(12) Patent Application Publication
(10) Pub. No.: US 2026/0081406 A1
(43) Pub. Date: Mar. 19, 2026

(54) WIRE HARNESS AND LIGHTING SYSTEM

(71) Applicant: HIRAKAWA HEWTECH CORPORATION, Tokyo (JP)

(72) Inventor: Junichi NAGASHIMA, Koga-shi (JP)

(21) Appl. No.: 19/325,882

(22) Filed: Sep. 11, 2025

(30) Foreign Application Priority Data
Sep. 13, 2024 (JP) 2024-159244

(51) Int. Cl. H02G 3/04; F21S 4/26; F21V 23/00; F21V 23/06; F21Y 115/10; H02G 15/013; H02G 15/18

(52) U.S. Cl. CPC H02G 3/0462; F21S 4/26; F21V 23/001; F21V 23/06; H02G 15/013; H02G 15/1806; F21Y 2115/10

(57) ABSTRACT

A wire harness includes a trunk line extending from an upstream side to a downstream side, a plurality of branching units respectively provided at each of a plurality of branching points on the trunk line, and a plurality of branch lines branching out from the plurality of branching units, wherein the trunk line includes a trunk conductor, wherein the branch line includes a branch conductor, and wherein the branching unit includes a conductor connection portion that electrically connects the trunk conductor on the upstream side to the trunk conductor on the downstream side and to the branch conductor, and a cover portion including an insulating material that covers the conductor connection portion and surroundings thereof.

### CROSS-REFERENCE TO RELATED APPLICATIONS

The present application is based on Japanese patent application No. 2024-159244 filed on Sep. 13, 2024, the entire contents of which are incorporated herein by reference.

### TECHNICAL FIELD

The present invention relates to a wire harness and a lighting system, i.e., lighting device, lighting apparatus, or the like.

### BACKGROUND OF THE INVENTION

In recent years, a waterproof socket to which a straight tube LED lamp can be directly connected, and a lighting device utilizing such a waterproof socket, have been proposed to reduce the number of parts and lower costs (see, e.g., Patent Literature 1).

The waterproof socket described in Patent Literature 1 accommodates a base portion of a straight tube LED lamp with a single-sided power supply on one end, supplying power to the straight tube LED lamp through a socket terminal that has a structure to connect one connecting wire to another. This allows power to be supplied to multiple straight-tube LED lamps from an external power source through the connecting wires, enabling the straight-tube LED lamps to be used, for example, in a lighting system for the artificial cultivation of vegetables.

Citation List Patent Literature 1: JP2017-107741A

### SUMMARY OF THE INVENTION

In conventional lighting systems, the straight tube LED lamps to be connected are directly connected to the waterproof sockets provided on the connecting wires, which causes a problem that the arrangement of the straight tube LED lamps is restricted by the waterproof sockets (e.g., the straight tube LED lamps cannot be placed away from the connecting wires).

It is an object of the invention to provide a wire harness that improves the degree of freedom in the arrangement of objects to be connected, and a lighting system using such a wire harness.

According to the first aspect, a wire harness comprises:
a trunk line extending from an upstream side to a downstream side;
a plurality of branching units respectively provided at each of a plurality of branching points on the trunk line; and
a plurality of branch lines branching out from the plurality of branching units,
wherein the trunk line comprises a trunk conductor,
wherein the branch line comprises a branch conductor, and
wherein the branching unit comprises a conductor connection portion that electrically connects the trunk conductor on the upstream side to the trunk conductor on the downstream side and to the branch conductor, and a cover portion comprising an insulating material that covers the conductor connection portion and surroundings thereof.

According to the second aspect, in the wire harness as described in the first aspect, the cover portion comprises a tubular body that covers the conductor connection portion and surroundings thereof, an inner molded body formed on the outside of the tubular body by resin molding, and an outer molded body formed on the outside of the inner molded body by resin molding.

According to the third aspect, in the wire harness as described in the second aspect, the inner molded body is formed on the outside of the tubular body by resin molding in a state that the tubular body is positioned, and the outer molded body is formed on the outside of the inner molded body by resin molding in a state that the inner molded body is positioned.

According to the fourth aspect, in the wire harness as described in the first aspect, the trunk line comprises a pair of trunk conductors, wherein the branch line comprises a pair of branch conductors, and wherein the conductor connection portion comprises a pair of conductor connection portions that respectively electrically connect the pair of trunk conductors on the upstream side to the pair of trunk conductors on the downstream side and to the pair of branch conductors.

According to the fifth aspect, in the wire harness as described in the first aspect, the conductor connection portion electrically connects the trunk conductor on the upstream side to the trunk conductor on the downstream side and to the branch conductor by means of crimping.

According to the sixth aspect, in the wire harness as described in the fifth aspect, the conductor connection portion comprises a straight butt sleeve.

According to the seventh aspect, in the wire harness as described in the second aspect, the tubular body comprises a heat shrink tube.

According to the eighth aspect, the wire harness as described in the seventh aspect further comprises: an adhesive that fills a gap between an inner surface of the heat shrink tube and the conductor connection portion and surroundings thereof.

According to the ninth aspect, in the wire harness as described in the fourth aspect, the trunk line on the most downstream side and the plurality of branch lines are each connected, at an end opposite the branching unit, to a plug connector.

According to the tenth aspect, in the wire harness as described in the ninth aspect, the plug connector comprises a fitting portion that faces in a direction orthogonal to a longitudinal direction of the branch line.

According to the eleventh aspect, a lighting system comprises:
the wire harness as described in the ninth or tenth aspect, and
a plurality of lighting fixtures comprising a plurality of receptacle connectors connected to a plurality of the plug connectors.

### Advantageous Effects of the Invention

According to the invention, it is possible to improve the degree of freedom in the arrangement of objects to be connected.

### BRIEF DESCRIPTION OF DRAWINGS

FIG. 1 is a plan view showing an example of a schematic configuration of a lighting system in an embodiment of the present invention.

FIGS. 2A to 2C are diagrams illustrating an example of the external shape of a branching unit, wherein FIG. 2A is a plan view thereof, FIG. 2B is a left side view thereof, and FIG. 2C is a right side view thereof.

FIGS. 2D to 2F are diagrams illustrating the example of the external shape of the branching unit, wherein FIG. 2D is a front view thereof, FIG. 2E is a back view thereof, and FIG. 2F is a bottom view thereof.

FIG. 3 is a cross-sectional view taken along line C-C of FIG. 2D.

FIG. 4A is an explanatory perspective view showing a method of connecting conductors.

FIG. 4B is a cross-sectional view taken along line D-D of FIG. 4A.

FIGS. 5A and 5B are diagrams illustrating an example of the external shape of an inner molded body, wherein FIG. 5A is a plan view thereof and FIG. 5B is a front view thereof.

FIG. 6 is a plan view showing an example of a plug connector in Modified Example 1.

### DETAILED DESCRIPTION OF THE INVENTION

Next, an embodiment of the invention will be described with reference to the drawings. In each drawing, constituent elements having substantially the same functions are denoted by the same reference signs and overlapping explanations thereof will be omitted.

### Embodiment

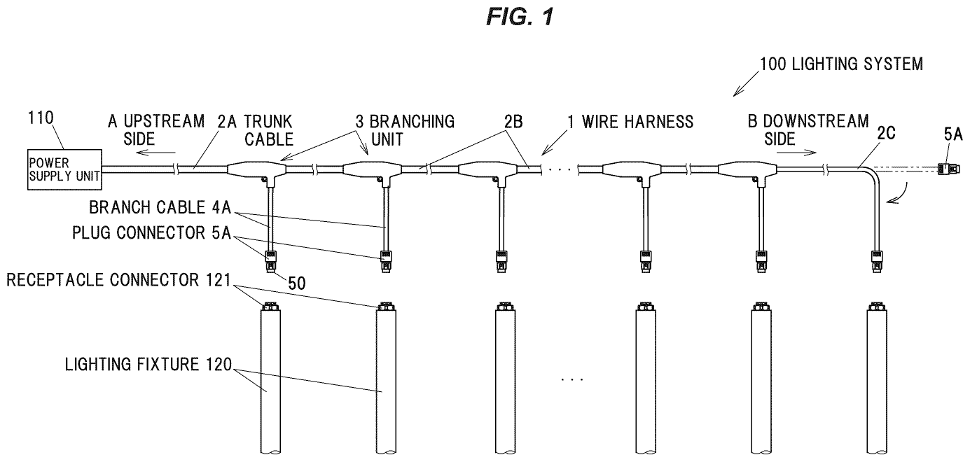

FIG. 1 is a plan view showing an example of a schematic configuration of a lighting system in an embodiment of the invention. A lighting system 100 has a power supply unit 110, plural (N) lighting fixtures each including a light source, i.e., luminaires, 120, and a wire harness 1 to supply power from the power supply unit 110 to the plural lighting fixtures 120. Here, the upstream side is indicated as A, and the downstream side is indicated as B. The power supply unit 110 is an example of a power supply device or an upstream device. The lighting fixture 120 is an example of an object to be connected or a downstream device. N is, e.g., 40, but may be 2.

The wire harness 1 includes a trunk cable 2A connected to the power supply unit 110, plural (N minus 2) trunk cables 2B sequentially connected to the trunk cable 2A, a trunk cable 2C connected to the trunk cable 2B on the most downstream side B among the plural trunk cables 2B, plural (N minus 1) branching units 3 provided one at each of plural branching points on the trunk cables 2A, 2B and 2C, plural (N minus 1) branch cables 4 branching out from the plural branching units 3, and plural (N) plug connectors 5A which are provided on end portions, on the opposite side to the branching units 3, of the trunk cable 2C on the most downstream side B and of the plural branch cables 4 and are connected to the plural lighting fixtures 120. Hereinafter, the trunk cables 2A, 2B, and 2C are also referred to as the trunk cable 2 when collectively called. The number of branching units 3 is usually not less than two, but may be one. The trunk cable 2 is an example of the trunk line. The branch cable 4 is an example of the branch line.

When the configuration of directly connecting the lighting fixtures 120 to the trunk cable 2 through waterproof sockets as in the conventional example is adopted, it is not possible to arrange the lighting fixtures 120 at positions away from the trunk cable 2 and the arrangement of the lighting fixtures 120 is restricted by the waterproof sockets. Therefore, in the present embodiment, a configuration of connecting the lighting fixtures 120 to the trunk cable 2 through the branch cables 4 is adopted. This allows the lighting fixtures 120 to be arranged at any position relative to the trunk cable 2 (e.g., positions away from or close to the trunk cable 2) or in any direction (e.g., in a direction parallel to or orthogonal to the trunk cable 2), thereby improving the degree of freedom in arrangement of the lighting fixtures 120.

Cables with the same length may be used as the plural trunk cables 2B. For example, the length of the trunk cable 2B may be slightly longer than the entire length of the lighting fixture 120. This allows the lighting fixture 120 to be arranged parallel to the trunk cable 2B. Alternatively, cables with different lengths may be used as the plural trunk cables 2B. In addition, the length of the trunk cable 2C located on the most downstream side B may be the sum of the length of the trunk cable 2B and the length of the branch cable 4. In this case, a portion of the trunk cable 2C on the plug connector 5A side indicated by an imaginary line in FIG. 1 can be arranged in the same direction as the branch cable 4 as indicated by a solid line in FIG. 1, allowing the trunk cable 2C to be treated in the same way as the branch cable 4.

For example, 2-core power cables having a pair of power wires are used as the trunk cable 2 and the branch cable 4 in the present embodiment. The detailed configurations of the trunk cable 2 and the branch cable 4 in the present embodiment are described later. In this regard, the trunk cable 2 and the branch cable 4 can be cables with a core configuration appropriate for the object to be connected, as shown below.
(i) Power cable having a ground wire and a pair of power wires
(ii) Power cable having three power wires
(iii) Signal cable having not less than two signal wires
(iv) Cable with not less than three cores, which has power and signal wires

The trunk cable 2 and the branch cable 4 may also be insulated wires in which plural conductors spaced apart are covered with a single insulation. The cables and insulated wire are examples of an electric wire.

A connector having poles in a number corresponding to the number of cores of the trunk cable 2C and the branch cable 4 can be used as the plug connector 5A. The plug connector 5A used in the present embodiment has poles in a number (two poles) corresponding to the number of cores (2 cores) of the trunk cable 2C and the branch cable 4. When waterproofing is required, the plug connector 5A preferably includes a waterproof sealing ring at a fitting portion 50. This makes it possible to achieve high waterproof performance (e.g., IPX7 of the IEC standard (ingress of water into the inside shall not be possible even when immersed in water under defined conditions of pressure and time), etc.), hence, the wire harness 1 can be installed outdoors or in locations where water spraying, etc. is performed (e.g., plant growth factories). The waterproof performance may be IPX6 (powerful water jets from any direction shall have no harmful effect) or IPX5 (water jets from any direction shall have no harmful effect) of the IEC standard.

For example, a straight tube LED lamp with single-sided power-supply can be used as the lighting fixture 120. The straight tube LED lamp includes a cylindrical pipe member made of an acrylic resin or a polycarbonate resin, etc., a pair of cap-shaped cover members that close both ends of the pipe member, a circuit board housed inside the pipe member and having plural LED elements mounted along the longitudinal direction, and a receptacle connector 121 provided on one of the pair of cover members and connected to the plug connector 5A. The LED element is an example of a light-emitting element. The light-emitting element is not limited to the LED element, and may be a fluorescent lamp, an incandescent lamp, an organic EL, or an inorganic EL, etc. The number of light-emitting elements may be one per branch cable 4 or trunk cable 2C. When waterproofing is required, the receptacle connector 121 preferably includes a waterproof sealing ring at a fitting portion. This makes it possible to achieve high waterproof performance (e.g., IPX7, etc., of the IEC standard). The waterproof performance may be IPX6 or IPX5, etc. of the IEC standard.

A power source compatible with the straight tube LED lamp constituting the lighting fixture 120 can be used as the power supply unit 110. In particular, an AC power source (e.g., AC 100V, AC 200V, etc.) can be used as the power supply unit 110 when the straight tube LED lamp has a built-in converter that converts AC power into DC power, and a DC power source (e.g., DC 12V, DC 24V, etc.) can be used as the power supply unit 110 when the straight tube LED lamp does not have such a built-in converter.

The downstream devices connected to the trunk cable 2C and the plural branch cables 4 are not limited to the lighting fixture 120, and may be devices shown below.
(i) Device that requires power supply
(ii) Device that requires power supply and also transmits/receives signals
(iii) Device that does not require power supply but transmits/receives signals

The upstream device connected to the trunk cable 2A on the upstream side A is not limited to the power supply unit 110, and may be devices shown below.
(i) Device that supplies power
(ii) Device that supplies power and also transmits/receives signals
(iii) Device that does not supply power but transmits/receives signals

Examples of signals transmitted and received between the upstream device and the downstream device include control signals and drive signals, etc.

### External Shape of Branching Unit

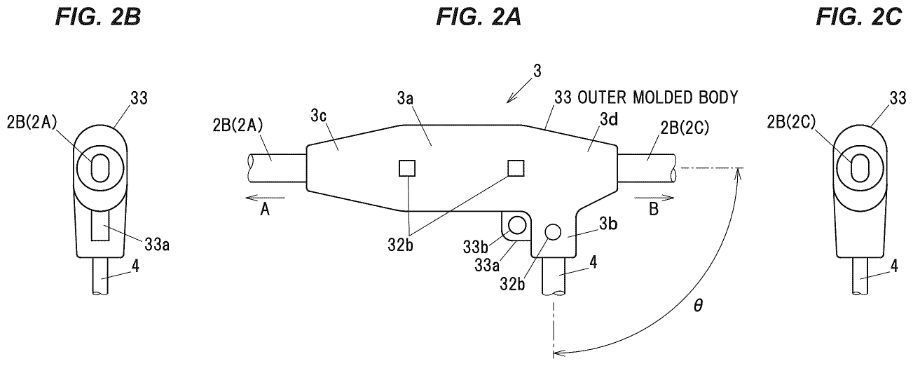

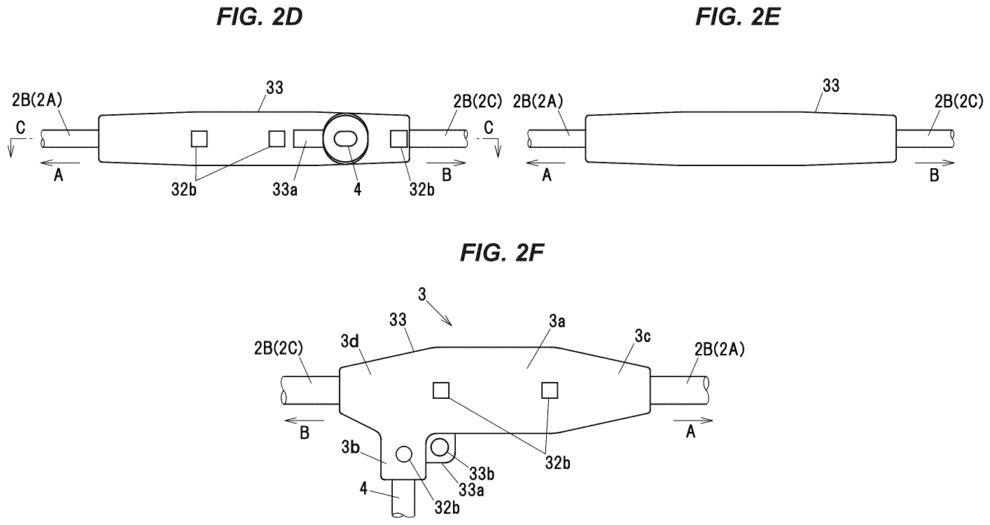

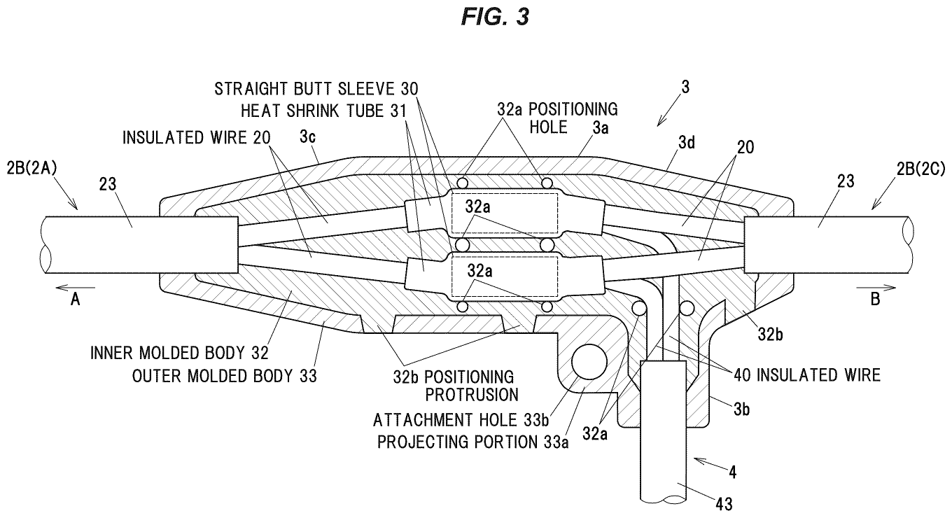

FIGS. 2A to 2F show an example of the external shape of the branching unit 3, wherein FIG. 2A is a plan view thereof, FIG. 2B is a left side view thereof, FIG. 2C is a right side view thereof, FIG. 2D is a front view thereof, FIG. 2E is a back view thereof, and FIG. 2F is a bottom view thereof. The branching unit 3 is composed of a trunk cable holding portion 3a formed along the trunk cable 2B and a branch cable holding portion 3b formed along the branch cable 4, has a substantially T-shape as a whole, and includes a pair of heat shrink tubes 31, an inner molded body 32 formed on the outside of the pair of heat shrink tubes 31 by resin molding, and an outer molded body 33 formed on the outside of the inner molded body 32 by resin molding as described later with reference to FIG. 3, where the shape of the outer molded body 33 formed on the outermost side determines the external shape of the branching unit 3. The trunk cable 2B (or the trunk cable 2A) extends out of the outer molded body 33 on the upstream side A, the trunk cable 2B (or the trunk cable 2C) extends out of the outer molded body 33 on the downstream side B, and the branch cable 4 extends out of the outer molded body 33 in a direction intersecting with the trunk cable 2B.

An extending angle θ of the branch cable 4 relative to the trunk cable 2B (2C) on the downstream side B is 90° in the present embodiment, but may be less than 90° (e.g., 45°) or may be more than 90° (e.g., 135°). The branch cable 4 may also extend out parallel to the trunk cable 2B (2C) (θ=0°). In this case, the branch cable 4 may be in contact with or separated from the trunk cable 2B (2C).

The trunk cable holding portion 3a is tapered at both ends 3c, 3d so that the inner molded body 32 and the outer molded body 33 do not have partially large wall thickness. This facilitates injection of molten resin into a cavity when forming the inner molded body 32 and the outer molded body 33 by injection molding, etc.

A projecting portion 33a protrudes near the intersection point of the substantially T-shape of the outer molded body 33, and an attachment hole 33b is formed on the projecting portion 33a. A cable tie can be inserted through the attachment hole 33b, and the branching unit 3 can be attached to a frame (e.g., a frame supporting the lighting fixture 120), etc. by the cable tie. The projecting portion 33a and the attachment hole 33b may be provided at another location, and may be provided at not less than two locations. Alternatively, the projecting portion 33a and the attachment hole 33b may not be provided.

### Internal Structure of Branching Unit

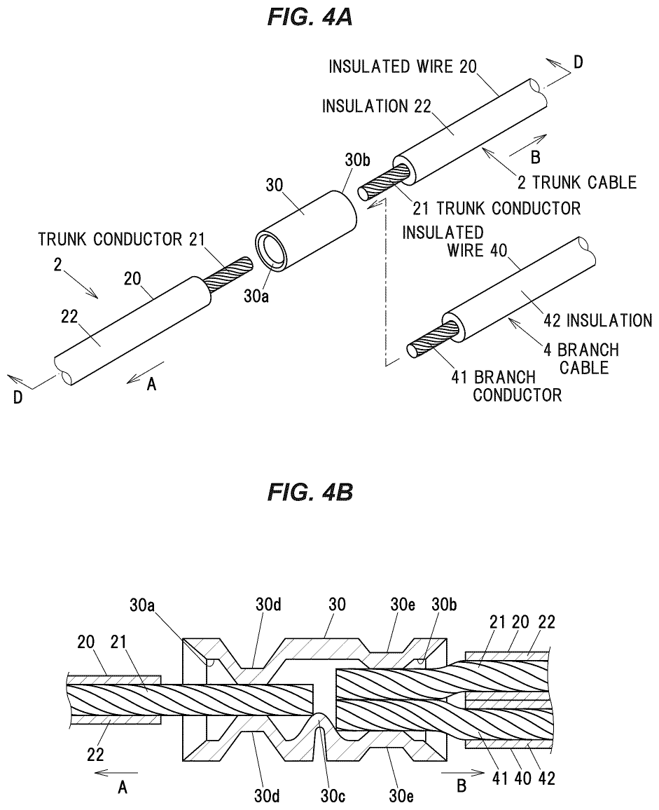

FIG. 3 is a cross-sectional view taken along line C-C of FIG. 2D. The trunk cable 2 is, e.g., a 2-core power cable in which a pair of insulated wires 20 are covered with a sheath 23. The branch cable 4 is, e.g., a 2-core power cable in which a pair of insulated wires 40 are covered with a sheath 43. The insulated wire 20 of the trunk cable 2 includes a trunk conductor 21 and an insulation 22 that covers the outer circumference of the trunk conductor 21, as shown in FIGS. 4A and 4B, which will be described later. The insulated wire 40 of the branch cable 4 includes a branch conductor 41 and an insulation 42 that covers the outer circumference of the branch conductor 41, as shown in FIGS. 4A and 4B, which will be described later. For example, stranded wires composed of multiple metal strands twisted together can be used as the trunk conductor 21 and the branch conductor 41. As the trunk conductor 21 and the branch conductor 41, solid wires may alternatively be used instead of the stranded wires. The insulations 22 and 42 are made of, e.g., a resin material such as polyvinyl chloride or polyethylene. The sheaths 23 and 43 are made of, e.g., a resin material such as polyvinyl chloride or polyethylene.

The branching unit 3 includes a pair of straight butt sleeves 30 that electrically connect the trunk conductors 21 of the pair of insulated wires 20 constituting the trunk cable 2 on the upstream side A to the trunk conductors 21 of the pair of insulated wires 20 constituting the trunk cable 2 on the downstream side B and to the branch conductors 41 of the pair of insulated wires 40 constituting the branch cable 4, a pair of heat shrink tubes 31 respectively covering the pair of straight butt sleeves 30 and respective surroundings, the inner molded body 32 formed on the outside of the heat shrink tubes 31 by resin molding in a state in which the pair of heat shrink tubes 31 are positioned relative to an inner molded body-forming mold, and the outer molded body 33 formed on the outside of the inner molded body 32 by resin molding in a state in which the inner molded body 32 is positioned relative to an outer molded body-forming mold. The straight butt sleeve 30 is an example of the conductor connection portion. The heat shrink tube 31 is an example of the tubular body. The heat shrink tube 31, the inner molded body 32 and the outer molded body 33 are examples of the cover portion made of an insulating material. The inner molded body 32 and the outer molded body 33 may alternatively be constructed from a single molded body.

For example, a non-insulated crimp-type sleeve for copper conductor conforming to JIS C2806 can be used as the straight butt sleeve 30. The straight butt sleeve 30 is made of, e.g., a soft conductive material (e.g., oxygen-free copper). The straight butt sleeve 30 is crimped in a state that the trunk conductor 21 on the upstream side A, the trunk conductor 21 on the downstream side B and the branch conductor 41, which are to be connected, are butting, thereby electrically connecting the trunk conductor 21 on the upstream side A to the trunk conductor 21 on the downstream side B and to the branch conductor 41. Alternatively, another sleeve electrically connecting conductors by crimping, or a connecting member electrically connecting conductors by welding or fusion, etc. may be used instead of the straight butt sleeve 30.

The heat shrink tube 31 is made of a polyethylene resin, a polyolefin resin, or a fluorine-based resin, etc., and shrinks in a radial direction under application of heat. The heat shrink tube 31 may be a heat shrink tube with hot melt adhesive, which is a double-layered tube having a layer of hot melt adhesive on the inner side (a commercially available product). In this case, heating the heat shrink tube with hot melt adhesive causes the heat shrink tube to shrink in the radial direction and also the hot melt adhesive to enter a gap between the inner surface of the heat shrink tube and the straight butt sleeve 30 and its surroundings (the insulated wires 20, 40, the conductors 21, 41, etc.), and it is thereby possible to fill the gap with the hot melt adhesive and achieve high waterproof performance (e.g., IPX7, etc. of the IEC standard). In this regard, a method in which a hot melt adhesive is applied to the straight butt sleeve 30 and its surroundings and the heat shrink tube 31 is then placed thereover, or a method in which a water-resistant adhesive (such as instant adhesive) is cured in advance and the heat shrink tube 31 is then placed thereover, can be used instead of using the heat shrink tube with hot melt adhesive. When taking into consideration the thickness control of the hot melt adhesive and the adhesion between the hot melt adhesive and the heat shrink tube 31 (which is difficult to achieve with a fluorine-based resin), the heat shrink tube with hot melt adhesive described above is preferable. The hot melt adhesive and the water-resistant adhesive are examples of the adhesive that fill the gap between the inner surface of the heat shrink tube and the conductor connection portion and its surroundings. As examples of the tubular body, a tubular molded body made of a resin may be used, or an insulating adhesive such as a hot melt adhesive may be applied, or an insulating tape may be wrapped around, instead of using the heat shrink tube 31.

The inner molded body 32 may be formed, e.g., by resin molding (e.g., injection molding, compression molding, extrusion molding, calendering molding, transfer molding, laminating molding, etc.) by using a soft resin material (e.g., soft polyvinyl chloride, polyethylene, etc.).

The outer molded body 33 may be formed, e.g., by resin molding (e.g., injection molding, compression molding, extrusion molding, calendering molding, transfer molding, laminating molding, etc.) by using a soft resin material (e.g., soft polyvinyl chloride, polyethylene, etc.).

Forming the inner molded body 32 and the outer molded body 33 using a soft resin material allows the branching unit 3 to have flexibility and it is thereby possible to reduce a load on the trunk cable 2 and the branch cable 4 at the time of laying the trunk cable 2 and the branch cable 4. In addition, forming the inner molded body 32 and the outer molded body 33 by injection molding allows for stable mass production with the same quality.

### Method of Connecting Conductors

FIG. 4A is an explanatory perspective view showing a method of connecting conductors, and FIG. 4B is a cross-sectional view taken along line D-D of FIG. 4A. The straight butt sleeve 30 has a cylindrical shape and includes a first opening 30a on one side for insertion of the trunk conductor 21 on the upstream side A, a second opening 30b on the other side for insertion of the trunk conductor 21 on the downstream side B and the branch conductor 41, and a wire stopper 30c provided in the center. The straight butt sleeve 30 is configured such that the trunk conductor 21 on the upstream side A is inserted into the first opening 30a until its tip hits the wire stopper 30c, the trunk conductor 21 on the downstream side B and the branch conductor 41 are inserted into the second opening 30b until their tips hit the wire stopper 30c, and a crimp portion 30d at the first opening 30a and a crimp portion 30e at the second opening 30b are crimped in a state in which the trunk conductor 21 on the upstream side A butts against the trunk conductor 21 on the downstream side B and the branch conductor 41 in a linear arrangement. It is thereby possible to easily electrically connect the trunk conductor 21 on the upstream side A to the trunk conductor 21 on the downstream side B and to the branch conductor 41.

### Configuration of Inner Molded Body

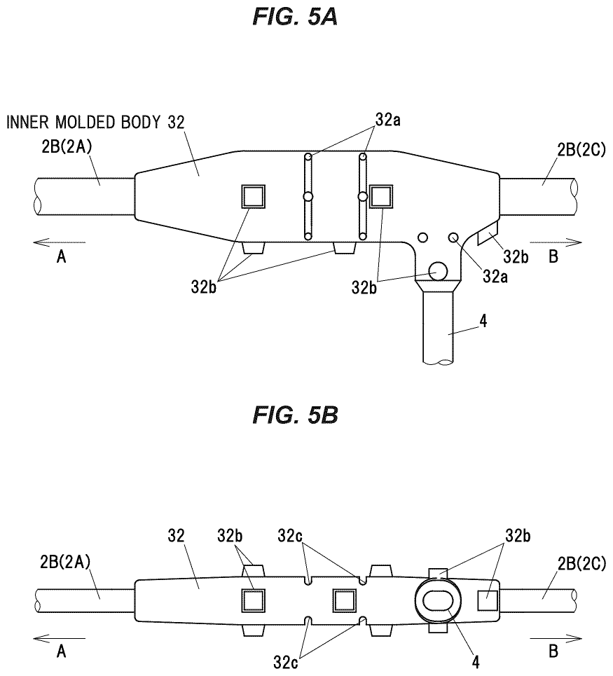

FIGS. 5A and 5B show an example of the external shape of the inner molded body 32, wherein FIG. 5A is a plan view thereof and FIG. 5B is a front view thereof. The inner molded body 32 includes plural positioning holes 32a through which positioning pins are inserted at the time of resin molding, plural positioning protrusions 32b for positioning of the inner molded body 32 at the time of resin molding of the outer molded body 33, and two grooves 32c. By providing the grooves 32c, the straight butt sleeves 30 with the heat shrink tubes 31 attached thereto can be positioned so as not to move in the up-down direction of FIG. 5B.

### Method for Manufacturing Wire Harness

Next, an example of a method for manufacturing the wire harness 1 will be described.

### 1. Preparation of Trunk Cable and Branch Cable

The trunk cable 2A to be located on the most upstream side A, plural trunk cables 2B to be connected to the trunk cable 2A, the trunk cable 2C to be located on the most downstream side B, and plural branch cables 4 are prepared. At this time, both ends of the trunk conductors 21 of the insulated wires 20 of the trunk cables 2A, 2B, 2C and both ends of the branch conductors 41 of the insulated wires 40 of the branch cables 4 are exposed.

2. Connecting Conductors with Straight Butt Sleeve

The trunk conductor 21 on the upstream side A is inserted into the first opening 30a of the straight butt sleeve 30 until its tip hits the wire stopper 30c, and the trunk conductor 21 on the downstream side B and the branch conductor 41 are inserted into the second opening 30b of the straight butt sleeve 30 until their tips hit the wire stopper 30c. Next, the crimp portion 30d at the first opening 30a and the crimp portion 30e at the second opening 30b are crimped. The trunk conductor 21 on the upstream side A is thereby electrically connected to the trunk conductor 21 on the downstream side B and to the branch conductor 41. The conductors are connected by a pair of straight butt sleeves 30 for one branching unit 3 as described above, and the conductors are connected for other branching units 3 in the same manner.

### 3. Attaching Heat Shrink Tube

The heat shrink tube 31 having hot melt adhesive on the inner side is placed over the straight butt sleeve 30 and its surroundings, and heat is applied to cause the heat shrink tube 31 to shrink in the radial direction, thereby covering the straight butt sleeve 30 and its surroundings with the heat shrink tube 31 through the hot melt adhesive. A pair of heat shrink tubes 31 having hot melt adhesive on the inner side are fitted around a pair of straight butt sleeves 30 and respective surroundings for one branching unit 3 as described above, and heat shrink tubes 31 are fitted for other branching units 3 in the same manner.

### 4. Positioning of Heat Shrink Tube

The pair of heat shrink tubes 31 fitted around the pair of straight butt sleeves 30 to which the trunk cable 2 and the branch cable 4 are connected are placed on a lower mold of the inner molded body-forming mold (not shown). At this time, as shown in FIG. 3, positioning pins are inserted into holes formed on the lower mold of the inner molded body-forming mold at positions corresponding to the positioning holes 32a, and the pair of heat shrink tubes 31 and the pair of insulated wires 40 of the branch cable 4 are positioned relative to the lower mold of the inner molded body-forming mold by the positioning pins. The upper mold of the inner molded body-forming mold also has holes into which the positioning pins are inserted.

### 5. Forming Inner Molded Body

For example, the inner molded body 32 is formed by injection molding. That is, the lower and upper molds of the inner molded body-forming mold are brought together, a molten first resin (e.g., soft polyvinyl chloride) is injected into a cavity (first space) between the lower and upper molds of the inner molded body-forming mold, and after the first resin cools and solidifies, the solidified molded article is released from the inner molded body-forming mold. The inner molded body 32 is thereby formed with the trunk cable 2 extending out toward the upstream side A and the trunk cable 2 and the branch cable 4 extending out toward the downstream side B. The positioning pins are then removed from the inner molded body-forming mold. One inner molded body 32 is formed for one branching unit 3 as described above, and inner molded bodies 32 are formed for the other branching units 3 in the same manner.

### 6. Forming Outer Molded Body

For example, the outer molded body 33 is formed by injection molding. That is, the inner molded body 32 is placed on a lower mold of the outer molded body-forming mold, and the lower and upper molds of the outer molded body-forming mold are brought together. At this time, the inner molded body 32 is positioned relative to the outer molded body-forming mold by the positioning protrusions 32b formed on the inner molded body 32. In this regard, the positioning protrusions 32b are provided only on the lower side in the papers of FIG. 3 and FIG. 5A since a molten second resin is injected from a sprue provided on the upper side and presses the inner molded body 32 downward. Therefore, depending on the position of the sprue, the positioning protrusions 32b may be provided at other locations.

Next, the molten second resin (e.g., soft polyvinyl chloride) is injected into a cavity (second space) between the lower and upper molds of the outer molded body-forming mold, and after the second resin cools and solidifies, the solidified molded article is released from the outer molded body-forming mold. The outer molded body 33 is thereby formed with the trunk cable 2 extending out toward the upstream side A and the trunk cable 2 and the branch cable 4 extending out toward the downstream side B. One outer molded body 33 is formed for one branching unit 3 as described above, and outer molded bodies 33 are formed for the other branching units 3 in the same manner.

### 7. Connecting Plug Connector

The plug connectors 5A are connected to ends of the trunk cable 2C on the most downstream side B and the plural branch cables 4. The wire harness 1 is manufactured through the above process. When in use, the trunk cable 2A on the most upstream side A is connected to the power supply unit 110.

The working sequence described above may be changed. For example, the plug connectors 5A may be connected to the ends of the trunk cable 2C and the plural branch cables 4 at the stage of preparing the trunk cable 2C and the branch cables 4.

### Advantageous Effects of the Embodiment

The present embodiment exerts the following advantageous effects.
(a) Since the lighting fixtures 120 are connected to the trunk cable 2 through the branch cables 4, the degree of freedom in the arrangement of the lighting fixtures 120 can be improved.
(b) The trunk conductor 21 on the upstream side A is connected to the trunk conductor 21 on the downstream side B and the branch conductor 41 by the straight butt sleeve 30, the straight butt sleeve 30 and its surroundings are covered with the heat shrink tube 31 through the hot melt adhesive, and the heat shrink tube 31 is further covered with a double-layered molded body composed of the inner molded body 32 and the outer molded body 33. Therefore, it is possible to enhance waterproof properties of the branching unit 3 and thereby achieve high waterproof performance (e.g., IPX7, etc., of the IEC standard). However, depending on the intended use, the waterproof performance may be lower than IPX7, such as IPX6 or IPX5, etc. of the IEC standard, or substantially no waterproof performance may be required.
(c) It is possible to supply power to the plural lighting fixtures 120 through the trunk cables 2B, 2C and the branch cables 4 that branch out from a single trunk cable 2A.

### Modified Example 1

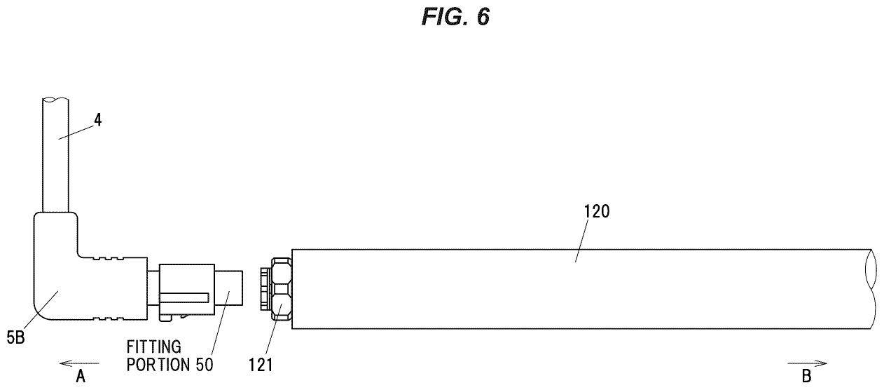

FIG. 6 is a plan view showing an example of a plug connector in Modified Example 1. The plug connector 5A in which the facing direction of the fitting portion 50 is the same as the longitudinal direction of the branch cable 4 is used in the above embodiment. In contrast, a plug connector 5B in Modified Example 1 is an L-shaped plug connector, and the fitting portion 50, into which the receptacle connector 121 of the lighting fixture 120 is fitted, faces in a direction perpendicular to the longitudinal direction of the branch cable 4. This allows the lighting fixture 120 to be arranged parallel to the trunk cable 2 without bending the branch cable 4.

A connector having poles in a number (two poles) corresponding to the number of cores (two cores) of the trunk cable 2C and the branch cable 4 is used as the plug connector 5B, in the same manner as the plug connector 5A. When waterproofing is required, the plug connector 5B preferably includes a waterproof sealing ring at the fitting portion 50. This makes it possible to achieve high waterproof performance (e.g., IPX7, etc. of the IEC standard). The waterproof performance may be IPX6 or IPX5, etc. of the IEC standard.

### EXAMPLES

Waterproof performance tests with and without hot-melt adhesive were conducted on the heat shrink tubes 31 constituting the branching unit 3. The test results are shown in Table 1.

### Test Objects

The following Examples 1 and 2 were tested. In Example 1, a heat shrink tube with hot melt adhesive (a commercially available product), which has a layer of hot melt adhesive on the inner side, was used as the heat shrink tube 31. In Example 2, a heat shrink tube not having a layer of hot melt adhesive on the inner side (no adhesive used) was used as the heat shrink tube 31. Each of the inner molded body 32 and the outer molded body 33 was formed by injection molding in both Examples 1 and 2.

### Judgment Criteria

Immediately after conducting the test for each waterproof performance rating of the IEC standard, a voltage of 1500 V was applied between poles for one minute. The presence or absence of dielectric breakdown was used as the judgment result. In the judgment results shown in Table 1, no dielectric breakdown (OK) is indicated by o, and dielectric breakdown occurred (NG) is indicated by x.

TABLE 1

| Waterproof | | | Judgment result | |
|---|---|---|---|---|
| performance | | | Example | Example |
| rating | Level of protection | Test method | 1 | 2 |
| IPX1 | Vertically falling water | Water drops at a rate of 3 | ∘ | ∘ |
| | drops shall have no harmful | to 5 mm/min from a height | | |
| | effect. | of 200 mm for 10 minutes | | |
| IPX2 | Rainfall at an angle within | Water drops at a rate of 3 | ∘ | ∘ |
| | 15° from the vertical to left | to 5 mm/min from a height | | |
| | and right shall have no | of 200 mm in the 15° | | |
| | harmful effect. | range for 10 minutes | | |
| IPX3 | Rainfall at an angle within | Water as a spray at a | ∘ | x |
| | 60° from the vertical to left | volume of 10 liters/min | | |
| | and right shall have no | from a height of 200 mm | | |
| | harmful effect. | in the 60° range for 10 | | |
| | | minutes | | |
| IPX4 | Water splashing from any | Water as a spray at a | ∘ | x |
| | direction shall have no | volume of 10 liters/min | | |
| | harmful effect. | from a height of 300 to | | |
| | | 500 mm in all directions | | |
| | | for 10 minutes | | |
| IPX5 | Water jets from any | Water jets at a volume of | ∘ | x |
| | direction shall have no | 12.5 liters/min and at 30 | | |
| | harmful effect. | kps from a distance of 3 m | | |
| | | in all directions for 3 | | |
| | | minutes | | |
| IPX6 | Powerful water jets from | Water jets at a volume of | ∘ | x |
| | any direction shall have no | 100 liters/min and at 100 | | |
| | harmful effect. | kps from a distance of 3 m | | |
| | | in all directions for 3 | | |
| | | minutes | | |
| IPX7 | Ingress of water into the | 15 cm to 1 m below the | ∘ | x |
| | inside shall not be possible | surface of the water, for 30 | | |
| | even when immersed in | minutes | | |
| | water under defined | | | |
| | conditions of pressure and | | | |
| | time | | | |

### Test Results

Example 1, in which a heat shrink tube with hot melt adhesive was used as the heat shrink tube 31, satisfied IPX1 to IPX7 of the IEC standard. Example 2, in which a heat shrink tube not using an adhesive was used as the heat shrink tube 31, satisfied IPX1 and IPX2 of the IEC standard. This shows that waterproof performance is significantly improved by providing a hot melt adhesive on the inner side of the heat shrink tube 31.

Although the embodiment of the invention has been described, embodiments of the invention are not to be limited to the embodiment described above, and various modifications can be implemented.

1. A wire harness, comprising:
a trunk line extending from an upstream side to a downstream side;
a plurality of branching units respectively provided at each of a plurality of branching points on the trunk line; and
a plurality of branch lines branching out from the plurality of branching units,
wherein the trunk line comprises a trunk conductor,
wherein the branch line comprises a branch conductor, and
wherein the branching unit comprises a conductor connection portion that electrically connects the trunk conductor on the upstream side to the trunk conductor on the downstream side and to the branch conductor, and a cover portion comprising an insulating material that covers the conductor connection portion and surroundings thereof.

2. The wire harness according to claim 1, wherein the cover portion comprises a tubular body that covers the conductor connection portion and surroundings thereof, an inner molded body formed on an outside of the tubular body by resin molding, and an outer molded body formed on an outside of the inner molded body by resin molding.

3. The wire harness according to claim 2, wherein the inner molded body is formed on the outside of the tubular body by resin molding in a state that the tubular body is positioned, and the outer molded body is formed on the outside of the inner molded body by resin molding in a state that the inner molded body is positioned.

4. The wire harness according to claim 1, wherein the trunk line comprises a pair of trunk conductors, wherein the branch line comprises a pair of branch conductors, and wherein the conductor connection portion comprises a pair of conductor connection portions that respectively electrically connect the pair of trunk conductors on the upstream side to the pair of trunk conductors on the downstream side and to the pair of branch conductors.

5. The wire harness according to claim 1, wherein the conductor connection portion electrically connects the trunk conductor on the upstream side to the trunk conductor on the downstream side and to the branch conductor by means of crimping.

6. The wire harness according to claim 5, wherein the conductor connection portion comprises a straight butt sleeve.

7. The wire harness according to claim 2, wherein the tubular body comprises a heat shrink tube.

8. The wire harness according to claim 7, further comprising:
an adhesive that fills a gap between an inner surface of the heat shrink tube and the conductor connection portion and surroundings thereof.

9. The wire harness according to claim 4, wherein the trunk line on a most downstream side and the plurality of branch lines are each connected, at an end opposite the branching unit, to a plug connector.

10. The wire harness according to claim 9, wherein the plug connector comprises a fitting portion that faces in a direction orthogonal to a longitudinal direction of the branch line.

11. A lighting system, comprising:
the wire harness according to claim 9; and
a plurality of lighting fixtures comprising a plurality of receptacle connectors connected to a plurality of the plug connectors.
